(19) United States
(12) Patent Application Publication
(10) Pub. No.: US 2009/0007969 A1
(43) Pub. Date: Jan. 8, 2009

(54) MICROFLUIDIC ACTUATION STRUCTURES

(75) Inventor: DOUGLAS B. GUNDEL, Cedar Park, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/773,737

(22) Filed: Jul. 5, 2007

(51) Int. Cl. F16K 31/68; B65D 83/00

(52) U.S. Cl. 137/15.18; 137/613; 137/628; 600/577; 422/103

(57) ABSTRACT

An article includes a microfluidic channel for moving fluid therethrough and at least one microfluidic actuator coupled to the microfluidic channel. The microfluidic actuator includes a deformable substance configured to enter the microfluidic channel to control fluid flow through the microfluidic channel. A method includes applying pressure to a deformable substance of a microfluidic actuator coupled to a microfluidic channel, such that the deformable substance of the microfluidic actuator enters the microfluidic channel. Another method includes inserting a needle into a microfluidic channel, applying pressure to a deformable substance of a microfluidic actuator coupled to the microfluidic channel, such that the deformable substance of the microfluidic actuator enters the microfluidic channel to form a seal around the needle, and injecting or extracting a fluid through the needle.

### TECHNICAL FIELD

The present invention relates to microfluidic actuation structures for providing precise, directed microfluidic actuation in microfluidic devices.

### BACKGROUND

Microfluidic devices are useful for manipulating fluid samples through the use of microfluidic actuation structures. A demand continues to exist for microfluidic actuation structures for use in microfluidic devices, and methods including these microfluidic actuation structures, that allow for precise, quick, reliable, and cost-effective processing of fluid samples.

### SUMMARY OF THE INVENTION

In one aspect, the present invention provides an article comprising a microfluidic channel for moving fluid therethrough and one or more microfluidic actuators coupled to the microfluidic channel. The one or more microfluidic actuators comprise a deformable substance configured to enter the microfluidic channel to control fluid flow through the microfluidic channel. The one or more microfluidic actuators may include one or more of an actuation channel coupled to the microfluidic channel, a chamber containing at least a portion of the deformable substance, an actuator base, and an actuator lid. The one or more microfluidic actuators may be configured to restrict or block fluid flow through the microfluidic channel.

In another aspect, the present invention provides a method comprising applying pressure to a deformable substance of one or more microfluidic actuators coupled to a microfluidic channel, such that the deformable substance of the one or more microfluidic actuators enters the microfluidic channel. The method may further include releasing pressure from the deformable substance of the one or more microfluidic actuators, such that the deformable substance of the one or more microfluidic actuators exits the microfluidic channel.

In yet another aspect, the present invention provides a method comprising inserting a needle into a microfluidic channel, applying pressure to a deformable substance of a microfluidic actuator coupled to the microfluidic channel, such that the deformable substance of the microfluidic actuator enters the microfluidic channel to form a seal around the needle, and injecting or extracting a fluid through the needle.

### BRIEF DESCRIPTION OF THE DRAWINGS

FIG. 1a is a cross-sectional view of an exemplary embodiment of a microfluidic actuation structure according to an aspect of the present invention in an initial stage.

FIG. 1b is a top view of the microfluidic actuation structure of FIG. 1a in an initial stage.

FIG. 1c is a cross-sectional view of the microfluidic actuation structure of FIG. 1a in an active stage.

FIG. 1d is a top view of the microfluidic actuation structure of FIG. 1a in an active stage.

FIG. 1e is a cross-sectional view of the microfluidic actuation structure of FIG. 1a returned to the initial stage.

FIG. 1f is a top view of the microfluidic actuation structure of FIG. 1a returned to the initial stage.

FIG. 2a is a cross-sectional view of another exemplary embodiment of a microfluidic actuation structure according to an aspect of the present invention in an initial stage.

FIG. 2b is a top view of the microfluidic actuation structure of FIG. 2a in an initial stage.

FIG. 2c is a cross-sectional view of the microfluidic actuation structure of FIG. 2a in an active stage.

FIG. 2d is a top view of the microfluidic actuation structure of FIG. 2a in an active stage.

FIG. 2e is a cross-sectional view of the microfluidic actuation structure of FIG. 2a remaining in the active stage.

FIG. 2f is a top view of the microfluidic actuation structure of FIG. 2a remaining in the active stage.

FIG. 3a is a cross-sectional view of another exemplary embodiment of a microfluidic actuation structure according to an aspect of the present invention in an initial stage.

FIG. 3b is a top view of the microfluidic actuation structure of FIG. 3a in an initial stage.

FIG. 3c is a cross-sectional view of the microfluidic actuation structure of FIG. 3a in an active stage.

FIG. 3d is a top view of the microfluidic actuation structure of FIG. 3a in an active stage.

FIG. 4a is a cross-sectional view of another exemplary embodiment of a microfluidic actuation structure according to an aspect of the present invention in an initial stage.

FIG. 4b is a top view of the microfluidic actuation structure of FIG. 4a in an initial stage.

FIG. 4c is a cross-sectional view of the microfluidic actuation structure of FIG. 4a in an active stage.

FIG. 4d is a top view of the microfluidic actuation structure of FIG. 4a in an active stage.

FIG. 5 is a schematic illustration of the operation of an exemplary embodiment of a microfluidic actuation structure according to an aspect of the present invention.

FIG. 6 is a schematic illustration of the operation of another exemplary embodiment of a microfluidic actuation structure according to an aspect of the present invention.

FIG. 7 is a schematic illustration of the operation of another exemplary embodiment of a microfluidic actuation structure according to an aspect of the present invention.

FIG. 8a is a cross-sectional view of another exemplary embodiment of a microfluidic actuation structure according to an aspect of the present invention in an initial stage.

FIG. 8b is a top view of the microfluidic actuation structure of FIG. 8a in an initial stage.

FIG. 8c is a cross-sectional view of the microfluidic actuation structure of FIG. 8a in an active stage.

FIG. 8d is a top view of the microfluidic actuation structure of FIG. 8a in an active stage.

FIG. 8e is a cross-sectional view of the microfluidic actuation structure of FIG. 8a remaining in the active stage.

FIG. 8f is a top view of the microfluidic actuation structure of FIG. 8a remaining in the active stage.

### DETAILED DESCRIPTION

In the following detailed description of the preferred embodiments, reference is made to the accompanying drawings that form a part hereof. The accompanying drawings show, by way of illustration, specific embodiments in which the invention may be practiced. It is to be understood that other embodiments may be utilized, and structural or logical changes may be made without departing from the scope of the present invention. The following detailed description, therefore, is not to be taken in a limiting sense, and the scope of the invention is defined by the appended claims.

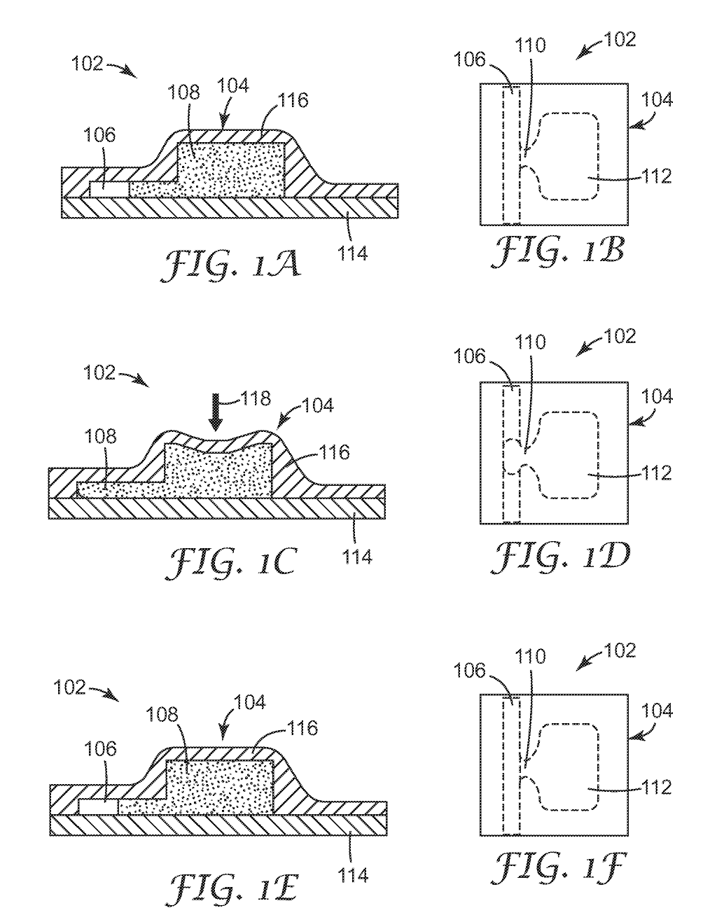

FIGS. 1A-1F illustrate an exemplary embodiment of a microfluidic actuation structure according to an aspect of the present invention. Microfluidic actuation structure 102 includes microfluidic actuator 104 coupled to microfluidic channel 106. Microfluidic actuator 104 may be coupled to microfluidic channel 106 directly or indirectly. The exemplary embodiment of FIGS. 1A-1F show an example of indirect coupling of microfluidic actuator 104 to microfluidic channel 106 whereby actuation channel 110 of microfluidic actuator 104 is coupled to microfluidic channel 106. Microfluidic actuator 104 includes deformable substance 108 configured to enter microfluidic channel 106 to control fluid flow through the microfluidic channel. In one embodiment, microfluidic actuator 104 includes chamber 112 containing at least a portion of deformable substance 108. In other embodiments, chamber 112 may be separate from microfluidic actuator 104. Deformable substance 108 may also be positioned in at least a portion of actuation channel 110. In the exemplary embodiment of FIGS. 1A-1F, microfluidic actuator 104 includes actuator base 114 and actuator lid 116. In this embodiment, actuator lid 116 is flexible to facilitate applying pressure to deformable substance 108, such that deformable substance 108 enters microfluidic channel 106. This may be accomplished by applying external force 118, as illustrated in FIG. 1C. In other embodiments, one or both of actuator base 114 and actuator lid 116 may be flexible. Alternatively, if actuator base 114 and actuator lid 116 are not flexible, then air or liquid pressure may be applied to chamber 112, e.g. by injected air, such that deformable substance 108 enters microfluidic channel 106. In the example of a valve, deformable substance 108 enters microfluidic channel 106 and restricts or blocks fluid flow through the microfluidic channel. This movement may additionally displace fluid in the microfluidic channel. In the exemplary embodiment of FIGS. 1A-1F, microfluidic actuator 104 is configured to temporarily restrict or block fluid flow through microfluidic channel 106 and may thereby serve as a returning valve. Specifically, when microfluidic actuation structure 102 is in an initial stage, as illustrated in FIGS. 1A-1B, deformable substance 108 is in an initial position. Applying external force 118 brings microfluidic actuation structure 102 in an active stage, as illustrated in FIGS. 1C-1D, whereby deformable substance 108 enters microfluidic channel 106 and restricts or blocks fluid flow through the microfluidic channel. Increasing the amount of external force 118 may increase the amount of pressure applied to deformable substance 108, which may increase the amount of restriction of fluid flow ultimately leading to complete blockage. As illustrated in FIGS. 1E-IF, due to the returning nature of actuator lid 116 in this embodiment, microfluidic actuation structure 102 returns to the initial stage when external force 118 is removed, whereby deformable substance 108 exits microfluidic channel 106.

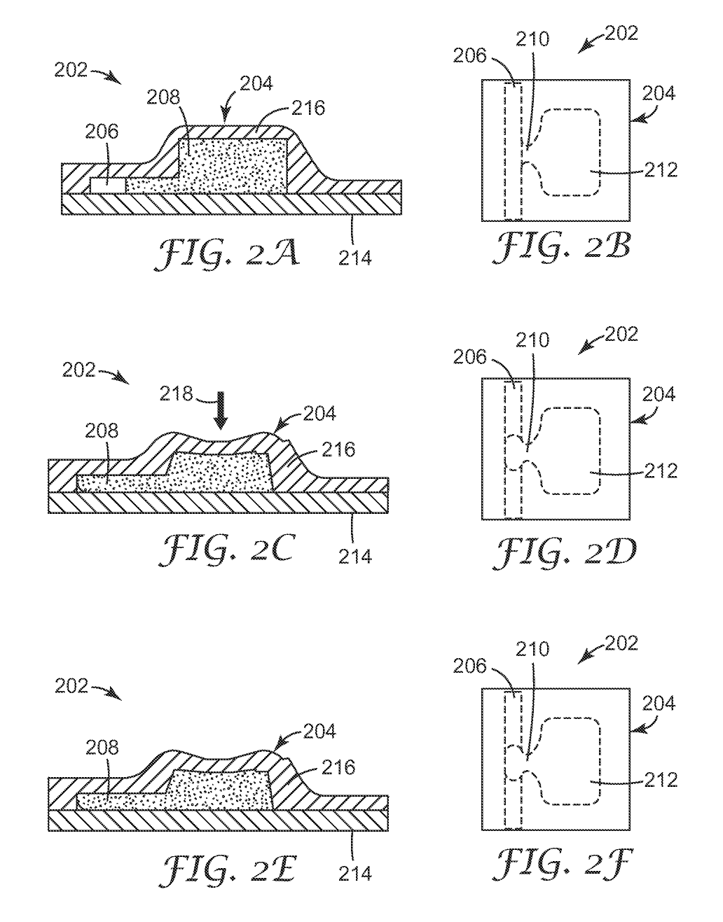

FIGS. 2A-2F illustrate another exemplary embodiment of a microfluidic actuation structure according to an aspect of the present invention. Microfluidic actuation structure 202 includes microfluidic actuator 204 coupled to microfluidic channel 206. Microfluidic actuator 204 may be coupled to microfluidic channel 206 directly or indirectly. The exemplary embodiment of FIGS. 2A-2F show an example of indirect coupling of microfluidic actuator 204 to microfluidic channel 206 whereby actuation channel 210 of microfluidic actuator 204 is coupled to microfluidic channel 206. Microfluidic actuator 204 includes deformable substance 208 configured to enter microfluidic channel 206 to control fluid flow through the microfluidic channel. In one embodiment, microfluidic actuator 204 includes chamber 212 containing at least a portion of deformable substance 208. In other embodiments, chamber 212 may be separate from microfluidic actuator 204. Deformable substance 208 may also be positioned in at least a portion of actuation channel 210. In the exemplary embodiment of FIGS. 2A-2F, microfluidic actuator 204 includes actuator base 214 and actuator lid 216. In this embodiment, actuator lid 216 is flexible to facilitate applying pressure to deformable substance 208, such that deformable substance 208 enters microfluidic channel 206. This may be accomplished by applying external force 218, as illustrated in FIG. 2C. In other embodiments, one or both of actuator base 214 and actuator lid 216 may be flexible. Alternatively, if actuator base 214 and actuator lid 216 are not flexible, then air or liquid pressure may be applied to chamber 212, e.g. by injected air, such that deformable substance 208 enters microfluidic channel 206. In the example of a valve, deformable substance 208 enters microfluidic channel 206 and restricts or blocks fluid flow through the microfluidic channel. This movement may additionally displace fluid in the microfluidic channel. In the exemplary embodiment of FIGS. 2A-2F, microfluidic actuator 204 is configured to permanently restrict or block fluid flow through microfluidic channel 206 and may thereby serve as a permanently-closed valve. Specifically, when microfluidic actuation structure 202 is in an initial stage, as illustrated in FIGS. 2A-2B, deformable substance 208 is in an initial position. Applying external force 218 brings microfluidic actuation structure 202 in an active stage, as illustrated in FIGS. 2C-2D, whereby deformable substance 208 enters microfluidic channel 206 and restricts or blocks fluid flow through the microfluidic channel. Increasing the amount of external force 218 may increase the amount of pressure applied to deformable substance 208, which may increase the amount of restriction of fluid flow ultimately leading to complete blockage. As illustrated in FIGS. 2E-2F, due to the non-returning nature of actuator lid 216 in this embodiment, microfluidic actuation structure 202 remains in the active stage when external force 218 is removed, whereby deformable substance 208 remains in microfluidic channel 206.

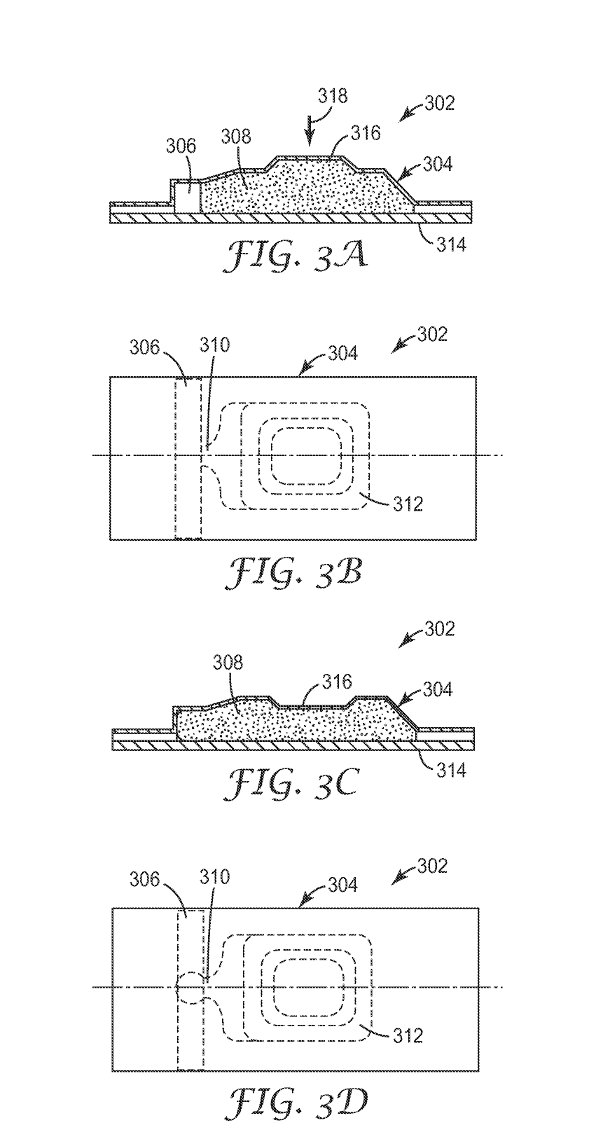

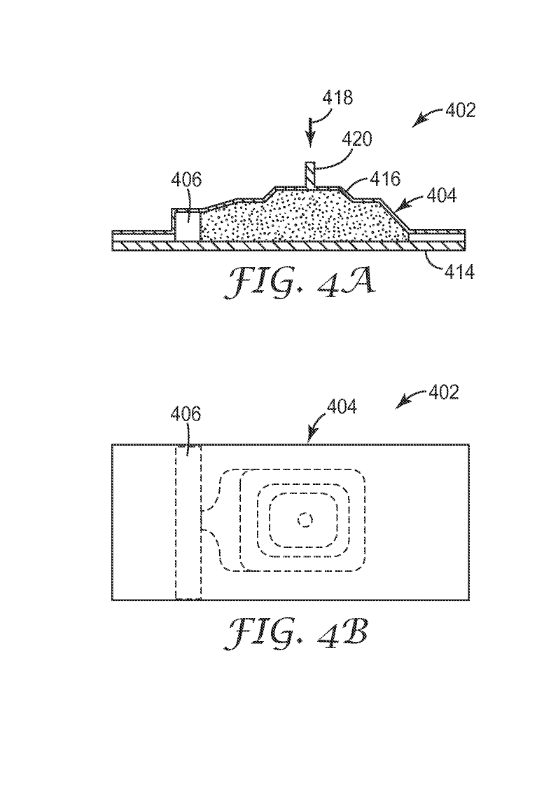

FIGS. 3A-3D show another exemplary embodiment of a microfluidic actuation structure according to an aspect of the present invention. Microfluidic actuation structure 302 includes microfluidic actuator 304 coupled to microfluidic channel 306. Microfluidic actuator 304 may be coupled to microfluidic channel 306 directly or indirectly. The exemplary embodiment of FIGS. 3A-3D show an example of indirect coupling of microfluidic actuator 304 to microfluidic channel 306 whereby actuation channel 310 of microfluidic actuator 304 is coupled to microfluidic channel 306. Microfluidic actuator 304 includes deformable substance 308 configured to enter microfluidic channel 306 to control fluid flow through the microfluidic channel. In one embodiment, microfluidic actuator 304 includes chamber 312 containing at least a portion of deformable substance 308. In other embodiments, chamber 312 may be separate from microfluidic actuator 304. Deformable substance 308 may also be positioned in at least a portion of actuation channel 310. In the exemplary embodiment of FIGS. 3A-3D, microfluidic actuator 304 includes actuator base 314 and actuator lid 316. In this embodiment, actuator lid 316 is flexible to facilitate applying pressure to deformable substance 308, such that deformable substance 308 enters microfluidic channel 306. This may be accomplished by applying external force 318, as illustrated in FIG. 3A. In other embodiments, one or both of actuator base 314 and actuator lid 316 may be flexible. In the example of a valve, deformable substance 308 enters microfluidic channel 306 and restricts or blocks fluid flow through the microfluidic channel. This movement may additionally displace fluid in the microfluidic channel. In the exemplary embodiment of FIGS. 3A-3D, microfluidic actuator 304 is configured to restrict or block fluid flow through microfluidic channel 306 in a bi-stable manner and may thereby serve as a bi-stable valve. Specifically, when microfluidic actuation structure 302 is in an initial stage, as illustrated in FIGS. 3A-3B, deformable substance 308 is in an initial position. Applying external force 318 brings microfluidic actuation structure 302 in an active stage, as illustrated in FIGS. 3C-3D, whereby deformable substance 308 enters microfluidic channel 306 and restricts or blocks fluid flow through the microfluidic channel. As illustrated in FIGS. 3C-3D, due to the non-returning nature of actuator lid 316 in this embodiment, microfluidic actuation structure 302 remains in the active stage when external force 318 is removed, whereby deformable substance 308 remains in microfluidic channel 306. In this embodiment, actuator lid 316 is configured such that when external force 318 is applied, at least a portion of the actuator lid moves from a stable initial position to a stable active position without permanently deforming or crushing the actuator lid. This bi-stable function of actuator lid 316 enables the actuator lid to toggle between the stable initial position and the stable active position. Actuator lid 316 can be returned to the stable initial position, e.g. by applying mechanical force of gripping actuator lid 316 (as shown and described in further detail below), pneumatic actuation, applying hydrostatic pressure from a connected actuator, or other suitable methods.

Similarly, in another exemplary embodiment (not shown), the microfluidic actuator can be configured to restrict or block fluid flow through a microfluidic channel in a multi-stable manner and may thereby serve as a multi-stable valve. Specifically, the actuator lid can be configured such that at least a portion of the actuator lid can move from a stable initial position to a number of different stable active positions by applying different amounts of external force without permanently deforming or crushing the actuator lid. This multi-stable function of the actuator lid enables the actuator lid to toggle between the stable initial position and the different stable active positions without the need to maintain the external force. Microfluidic actuation structures with bi-stable and multi-stable properties as described above can be made, e.g., by using a polymer micromolding process.

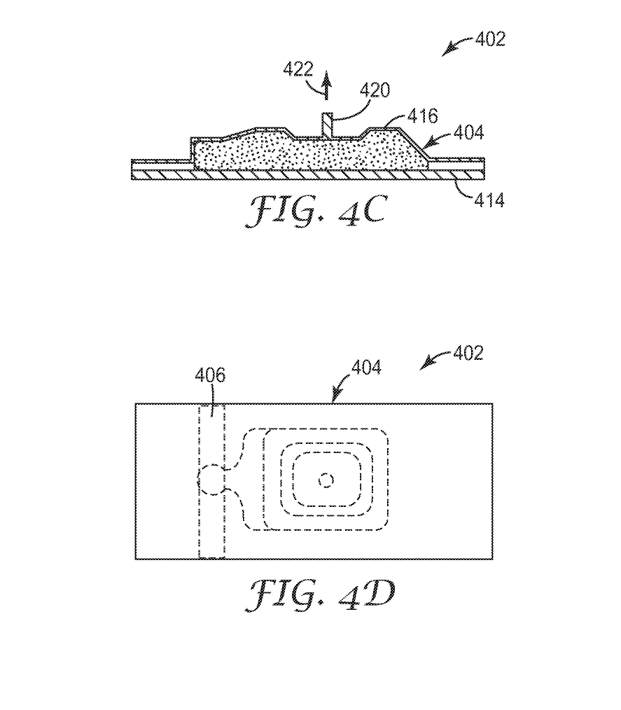

FIGS. 4A-4D show another exemplary embodiment of a microfluidic actuation structure according to an aspect of the present invention. Microfluidic actuation structure 402 is similar to the microfluidic actuation structure illustrated in FIGS. 3A-3D and includes a microfluidic actuator 404 coupled to microfluidic channel 406. Microfluidic actuator 404 includes actuator base 414 and actuator lid 416. Actuator lid 416 is configured such that when external force 418 is applied (as shown in FIG. 4A), at least a portion of the actuator lid moves from a stable initial position to a stable active position without permanently deforming or crushing the actuator lid, and when lifting force 422 is applied (as shown in FIG. 4C), at least a portion of the actuator lid moves from a stable active position to a stable initial position without permanently deforming or crushing the actuator lid. This bi-stable function of actuator lid 416 enables the actuator lid to toggle between the stable initial position and the stable active position without the need to maintain external force 418 or lifting force 422. In this embodiment, actuator lid 416 includes a gripping feature 420 to facilitate applying external force 418 or lifting force 422 to actuator lid 416.

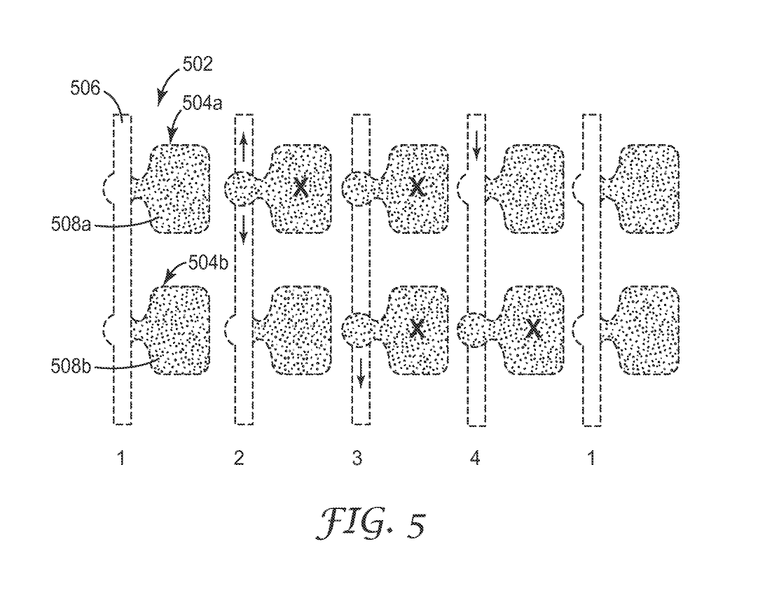

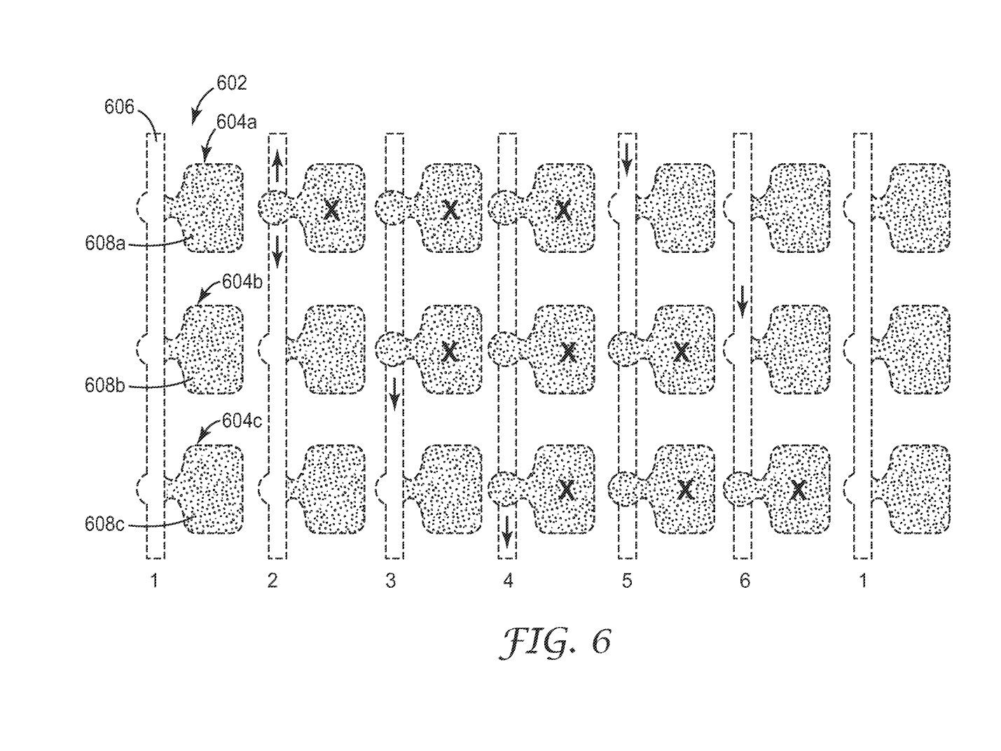

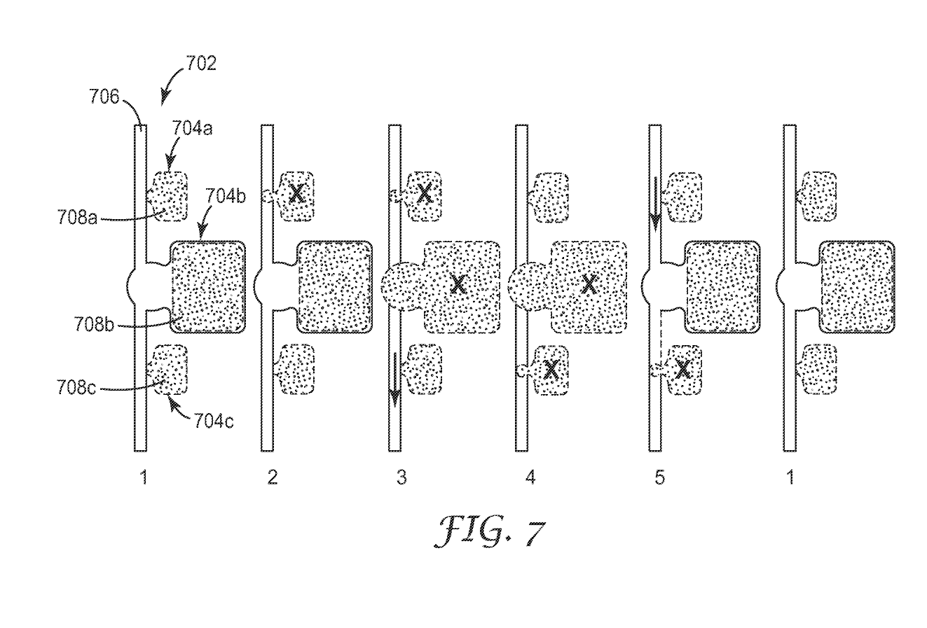

The exemplary embodiments of a microfluidic actuation structure described above include a microfluidic actuator coupled to a microfluidic channel and are relatively basic structures. A large variety of more complex structures can be created using one or more microfluidic actuators coupled to one or more microfluidic channels, e.g. to provide pumping and valving that can be choreographed to mix, react, separate, pump, and analyze microfluidic samples. Examples of more complex microfluidic actuation structures are basic pumps (an example of which is shown in FIG. 5), peristaltic pumps (an example of which is shown in FIG. 6), and displacement pumps (an example of which is shown in FIG. 7). The relatively basic and more complex structures can be used individually or in combination with one or more other microfluidic actuation structures and/or one or more microfluidic elements (such as an inlet, an outlet, an input/output (I/O) port, a reservoir, a mixing chamber, a reaction chamber, a heating chamber, a heating element, a turbulence feature, a separation channel, an electrode, a valve, a pump, a filter, a membrane, a sensor, a reagent, a mixing channel, etc.) to make a complete microfluidic device. The external actuation necessary for these microfluidic devices can readily be available by thermal, pneumatic, electromagnetic, or other suitable type actuators. The microfluidic actuation structures according to an aspect of the present invention can be incorporated in a polymeric substrate, and are suitable for application in both polymeric microfluidic devices and non-polymeric microfluidic devices.

FIG. 5 illustrates the operation of an exemplary embodiment of a microfluidic actuation structure according to an aspect of the present invention. Specifically, it shows how a microfluidic actuation structure according to an aspect of the present invention can be used as a basic pump moving fluid through a channel. Microfluidic actuation structure 502 includes two adjacently positioned microfluidic actuators 504a-b coupled to microfluidic channel 506. Each of microfluidic actuators 504a-b can be designed as microfluidic actuator 104 as described above or can be any other suitable microfluidic actuator configured to temporarily block fluid flow through microfluidic channel 506.

In the exemplary embodiment of FIG. 5, each of microfluidic actuators 504a-b includes a deformable substance, indicated as 508a-b respectively, configured to enter microfluidic channel 506 to temporarily block fluid flow through the microfluidic channel. This may be accomplished by applying pressure to the deformable substance, e.g., as described above. As illustrated in FIG. 5, in step 1, microfluidic actuation structure 502 is in an initial stage, whereby the deformable substance of each of the microfluidic actuators 504a-b is in an initial position. In step 2, pressure (as indicated by X) is applied to deformable substance 508a of microfluidic actuator 504a coupled to microfluidic channel 506, such that deformable substance 508a enters microfluidic channel 506, thereby blocking fluid flow through the microfluidic channel and displacing fluid in the microfluidic channel (as indicated by the arrows). In step 3, while pressure is maintained on deformable substance 508a of microfluidic actuator 504a, pressure is applied to deformable substance 508b of microfluidic actuator 504b coupled to microfluidic channel 506, such that deformable substance 508b enters microfluidic channel 506, thereby blocking fluid flow through the microfluidic channel and further displacing fluid in the microfluidic channel (as indicated by the arrow). In step 4, while pressure is maintained on deformable substance 508b of microfluidic actuator 504b, pressure is released from deformable substance 508a of microfluidic actuator 504a, such that deformable substance 508a exits microfluidic channel 506, thereby enabling fluid flow through the microfluidic channel (as indicated by the arrow). Subsequently, pressure is released from deformable substance 508b of microfluidic actuator 504b, such that deformable substance 508b exits microfluidic channel 506, thereby returning microfluidic actuation structure 502 to the initial stage.

FIG. 6 illustrates the operation of another exemplary embodiment of a microfluidic actuation structure according to an aspect of the present invention. Specifically, it shows how a microfluidic actuation structure according to an aspect of the present invention can be used as a peristaltic pump moving fluid through a channel. Microfluidic actuation structure 602 includes three adjacently positioned microfluidic actuators 604a-c coupled to microfluidic channel 606. Each of microfluidic actuators 604a-c can be designed as microfluidic actuator 104 as described above or can be any other suitable microfluidic actuator configured to temporarily block fluid flow through microfluidic channel 606.

In the exemplary embodiment of FIG. 6, each of microfluidic actuators 604a-c includes a deformable substance, indicated as 608a-c respectively, configured to enter microfluidic channel 606 to temporarily block fluid flow through the microfluidic channel. This may be accomplished by applying pressure to the deformable substance, e.g., as described above. As illustrated in FIG. 6, in step 1, microfluidic actuation structure 602 is in an initial stage, whereby the deformable substance of each of the microfluidic actuators 604a-c is in an initial position. In step 2, pressure (as indicated by X) is applied to deformable substance 608a of microfluidic actuator 604a coupled to microfluidic channel 606, such that deformable substance 608a enters microfluidic channel 606, thereby blocking fluid flow through the microfluidic channel and displacing fluid in the microfluidic channel (as indicated by the arrows). In step 3, while pressure is maintained on deformable substance 608a of microfluidic actuator 604a, pressure is applied to deformable substance 608b of microfluidic actuator 604b coupled to microfluidic channel 606, such that deformable substance 608b enters microfluidic channel 606, thereby blocking fluid flow through the microfluidic channel and further displacing fluid in the microfluidic channel (as indicated by the arrow). In step 4, while pressure is maintained on deformable substance 608a of microfluidic actuator 604a and deformable substance 608b of microfluidic actuator 604b, pressure is applied to deformable substance 608c of microfluidic actuator 604c coupled to microfluidic channel 606, such that deformable substance 608c enters microfluidic channel 606, thereby blocking fluid flow through the microfluidic channel and further displacing fluid in the microfluidic channel (as indicated by the arrow). In step 5, while pressure is maintained on deformable substance 608b of microfluidic actuator 604b and deformable substance 608c of microfluidic actuator 604c, pressure is released from deformable substance 608a of microfluidic actuator 604a, such that deformable substance 608a exits microfluidic channel 606, thereby enabling fluid flow through the microfluidic channel (as indicated by the arrow). In step 6, while pressure is maintained on deformable substance 608c of microfluidic actuator 604c, pressure is released from deformable substance 608b of microfluidic actuator 604b, such that deformable substance 608b exits microfluidic channel 606, thereby further enabling fluid flow through the microfluidic channel (as indicated by the arrow). Subsequently, pressure is released from deformable substance 608c of microfluidic actuator 604c, such that deformable substance 608c exits microfluidic channel 606, thereby returning microfluidic actuation structure 602 to the initial stage.

FIG. 7 illustrates the operation of another exemplary embodiment of a microfluidic actuation structure according to an aspect of the present invention. Specifically, it shows how a microfluidic actuation structure according to an aspect of the present invention can be used as a displacement pump moving fluid through a channel. Microfluidic actuation structure 702 includes three adjacently positioned microfluidic actuators 704a-c coupled to microfluidic channel 706. Each of microfluidic actuators 704a-c can be designed as microfluidic actuator 104 as described above or can be any other suitable microfluidic actuator configured to temporarily block fluid flow through microfluidic channel 706. In this embodiment, microfluidic actuator 704b is substantially larger than microfluidic actuators 704a and 704c. This configuration can facilitate a relatively large amount of fluid flow with a single actuation of microfluidic actuator 704b.

In the exemplary embodiment of FIG. 7, each of microfluidic actuators 704a-c includes a deformable substance, indicated as 708a-c respectively, configured to enter microfluidic channel 706 to temporarily block fluid flow through the microfluidic channel. This may be accomplished by applying pressure to the deformable substance, e.g., as described above. As illustrated in FIG. 7, in step 1, microfluidic actuation structure 702 is in an initial stage, whereby the deformable substance of each of the microfluidic actuators 704a-c is in an initial position. In step 2, pressure (as indicated by X) is applied to deformable substance 708a of microfluidic actuator 704a coupled to microfluidic channel 706, such that deformable substance 708a enters microfluidic channel 706, thereby blocking fluid flow through the microfluidic channel. In step 3, while pressure is maintained on deformable substance 708a of microfluidic actuator 704a, pressure is applied to deformable substance 708b of microfluidic actuator 704b coupled to microfluidic channel 706, such that deformable substance 708b enters microfluidic channel 706, thereby blocking fluid flow through the microfluidic channel and displacing fluid in the microfluidic channel (as indicated by the arrow). In step 4, while pressure is maintained on deformable substance 708b of microfluidic actuator 704b, pressure is applied to deformable substance 708c of microfluidic actuator 704c coupled to microfluidic channel 706, such that deformable substance 708c enters microfluidic channel 706, thereby blocking fluid flow through the microfluidic channel. Simultaneously or subsequently, pressure is released from deformable substance 708a of microfluidic actuator 704a, such that deformable substance 708a exits microfluidic channel 706. In step 5, while pressure is maintained on deformable substance 708c of microfluidic actuator 704c, pressure is released from deformable substance 708b of microfluidic actuator 704b, such that deformable substance 708b exits microfluidic channel 706, thereby enabling fluid flow through the microfluidic channel (as indicated by the arrow). Subsequently, pressure is released from deformable substance 708c of microfluidic actuator 704c, such that deformable substance 708c exits microfluidic channel 706, thereby returning microfluidic actuation structure 702 to the initial stage. In an alternative aspect, instead of microfluidic actuators 704a and 704c, passive valves or valves of any other type can be used.

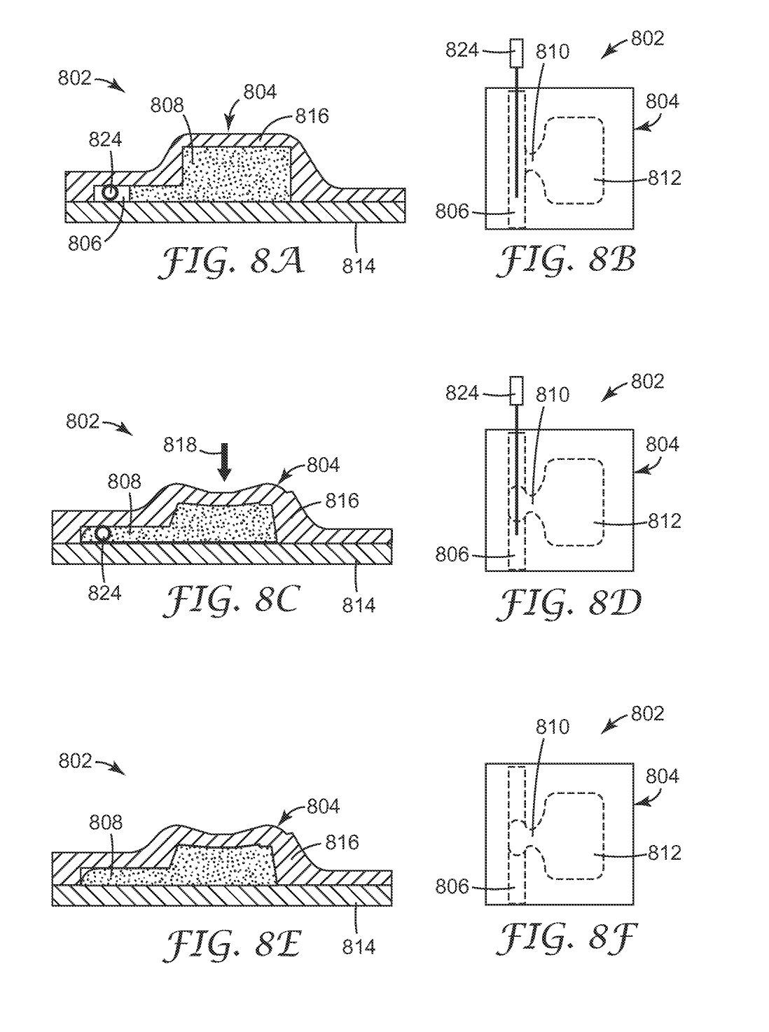

FIGS. 8A-8F illustrate another exemplary embodiment of a microfluidic actuation structure according to an aspect of the present invention. Microfluidic actuation structure 802 includes microfluidic actuator 804 coupled to microfluidic channel 806. Microfluidic actuator 804 may be coupled to microfluidic channel 806 directly or indirectly. The exemplary embodiment of FIGS. 8A-8F show an example of indirect coupling of microfluidic actuator 804 to microfluidic channel 806 whereby actuation channel 810 of microfluidic actuator 804 is coupled to microfluidic channel 806. Microfluidic actuator 804 includes deformable substance 808 configured to enter microfluidic channel 806 to control fluid flow through the microfluidic channel. In one embodiment, microfluidic actuator 804 includes chamber 812 containing at least a portion of deformable substance 808. In other embodiments, chamber 812 may be separate from microfluidic actuator 804. Deformable substance 808 may also be positioned in at least a portion of actuation channel 810. In the exemplary embodiment of FIGS. 8A-8F, microfluidic actuator 804 includes actuator base 814 and actuator lid 816. In this embodiment, actuator lid 816 is flexible to facilitate applying pressure to deformable substance 808, such that deformable substance 808 enters microfluidic channel 806. This may be accomplished by applying external force 818, as illustrated in FIG. 8C. In other embodiments, one or both of actuator base 814 and actuator lid 816 may be flexible. In the exemplary embodiment of FIGS. 8A-8F, microfluidic actuator 804 is configured to permanently block fluid flow through microfluidic channel 806 and form a seal around a needle 824 and may thereby serve as an active inlet or outlet seal. Needle 824 can be any suitable hollow tube configured to transport a fluid. Specifically, when microfluidic actuation structure 802 is in an initial stage, as illustrated in FIGS. 8A-8B, deformable substance 808 is in an initial position. In this stage, needle 824 can be inserted into microfluidic channel 806. Applying external force 818 brings microfluidic actuation structure 802 in an active stage, as illustrated in FIGS. 8C-8D, whereby deformable substance 808 enters microfluidic channel 806 and forms a seal around needle 824. This allows injection of a fluid into or extraction of a fluid from microfluidic channel 806 through needle 824 without leaks. As illustrated in FIGS. 8E-8F, due to the non-returning nature of actuator lid 816 in this embodiment, microfluidic actuation structure 802 remains in the active stage when external force 818 is removed, whereby the seal remains intact, even after needle 824 is removed. In an alternative embodiment, the actuator lid may have a returning nature, whereby the microfluidic actuation structure returns to the initial stage when the external force is removed so that the needle may be removed from channel 806.

Microfluidic actuation structures according to an aspect of the present invention can be made of a variety of suitable materials, including but not limited to polymers such as polycarbonate, polycarbonate/acrylonitrile butadiene styrene blends, acrylonitrile butadiene styrene, polyvinyl chloride, polystyrene, polypropylene oxide, acrylics, polybutylene terephthalate and polyethylene terephthalate blends, nylons, blends of nylons, and combinations thereof. Dependent on the desired function, the material can be elastically deformable or non-deformable (crushable). Given the tremendous diversity of polymer chemistries, precursors, synthetic methods, reaction conditions, and potential additives, there are a huge number of possible polymer systems known to one of skill in the art that could be used to make microfluidic actuation structures. In addition, non-polymer materials or combinations of polymer and non-polymer materials known to one of skill in the art may be used.

The deformable substance used in microfluidic actuation structures according to an aspect of the present invention can be made of a variety of suitable materials. The deformability exhibited by a suitable material may be characterized by an elastic modulus, also referred to as Young's modulus. Materials having an elastic modulus of 1 kPa to 1000 kPa are useful in accordance with at least one aspect of the present invention, although materials having an elastic modulus outside of this range could also be utilized depending upon the needs of a particular application. Suitable materials include but are certainly not limited to elastomeric polymers such as polyisoprene, polybutadiene, polychloroprene, polyisobutylene, poly(styrene-butadiene-styrene), polyurethanes, and silicones. In general, elastomeric polymers deform when force is applied, but then return to their original shape when the force is removed, which would facilitate the function of the deformable substance used in microfluidic actuation structures according to aspects of the present invention. In an exemplary aspect, the deformable substance used in microfluidic actuation structures according to an aspect of the present invention may include silicone rubber. Given the tremendous diversity of polymer chemistries, precursors, synthetic methods, reaction conditions, and potential additives, there are a huge number of possible elastomeric polymer systems known to one of skill in the art that could be used to make the deformable substance used in microfluidic actuation structures according to an aspect of the present invention. In addition, non-polymer materials or combinations of polymer and non-polymer materials known to one of skill in the art may be used. Variations in the materials used will most likely be driven by the need for particular material properties, i.e., solvent resistance, stiffness, gas permeability, temperature stability, etc.

The microfluidic channels according to an aspect of the present invention can be designed to accommodate any desired transport of fluids. For example, the channels can have a curvilinear (e.g. round or oval), rectilinear, or any other suitable cross-section geometry. The channels can have a constant or variable cross-section geometry over a channel length, and the channels may include additional elements such as wells, reservoirs, inlets, outlets, etc.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the mechanical and fluidic arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. An article comprising:
a microfluidic channel for moving fluid therethrough; and
a first microfluidic actuator coupled to the microfluidic channel and comprising a deformable substance configured to enter the microfluidic channel to control fluid flow through the microfluidic channel.

2. The article of claim 1, wherein the first microfluidic actuator further comprises an actuation channel coupled to the microfluidic channel.

3. The article of claim 2, wherein the deformable substance is positioned in at least a portion of the actuation channel.

4. The article of claim 1, wherein the first microfluidic actuator further comprises a chamber containing at least a portion of the deformable substance.

5. The article of claim 4, wherein the first microfluidic actuator further comprises an actuator base and an actuator lid.

6. The article of claim 5, wherein at least one of the actuator base and actuator lid is flexible.

7. The article of claim 1, wherein the deformable substance comprises a material having an elastic modulus of 1 kPa to 1000 kPa.

8. The article of claim 1, wherein the first microfluidic actuator is configured to temporarily restrict or block fluid flow through the microfluidic channel.

9. The article of claim 1, wherein the first microfluidic actuator is configured to permanently restrict or block fluid flow through the microfluidic channel.

10. The article of claim 1, wherein the fluid is moved through the channel by actuating the first microfluidic actuator.

11. The article of claim 1 further comprising:
a second microfluidic actuator coupled to the microfluidic channel and comprising a deformable substance configured to enter the microfluidic channel to control fluid flow through the microfluidic channel,
wherein the fluid is moved through the channel by selectively actuating the microfluidic actuators.

12. The article of claim 11, wherein the fluid is moved through the channel by sequentially actuating the microfluidic actuators.

13. The article of claim 11, wherein the second microfluidic actuator is of substantially different size than the first microfluidic actuator.

14. The article of claim 1, wherein the article is incorporated in a microfluidic device.

15. The article of claim 1, wherein the article is incorporated in a polymeric substrate.

16. The article of claim 1 further comprising a microfluidic element coupled to the microfluidic channel.

17. A method comprising:
applying pressure to a deformable substance of a first microfluidic actuator coupled to a microfluidic channel, such that the deformable substance of the first microfluidic actuator enters the microfluidic channel.

18. The method of claim 17 further comprising:
while maintaining pressure on the deformable substance of the first microfluidic actuator, applying pressure to a deformable substance of a second microfluidic actuator coupled to the microfluidic channel and positioned adjacent to the first microfluidic actuator, such that the deformable substance of the second microfluidic actuator enters the microfluidic channel.

19. The method of claim 18 further comprising:
while maintaining pressure on the deformable substance of the second microfluidic actuator, releasing pressure from the deformable substance of the first microfluidic actuator, such that the deformable substance of the first microfluidic actuator exits the microfluidic channel; and
subsequently releasing pressure from the deformable substance of the second microfluidic actuator, such that the deformable substance of the second microfluidic actuator exits the microfluidic channel.

20. The method of claim 18 further comprising:
while maintaining pressure on the deformable substance of the second microfluidic actuator, applying pressure to a deformable substance of a third microfluidic actuator coupled to the microfluidic channel and positioned adjacent to the second microfluidic actuator, such that the deformable substance of the third microfluidic actuator enters the microfluidic channel; and
while maintaining pressure on the deformable substance of the second microfluidic actuator, releasing pressure from the deformable substance of the first microfluidic actuator, such that the deformable substance of the first microfluidic actuator exits the microfluidic channel.

21. The method of claim 20, wherein the second microfluidic actuator is substantially larger than the first and third microfluidic actuator.

22. A method comprising:
inserting a needle into a microfluidic channel;
applying pressure to a deformable substance of a microfluidic actuator coupled to the microfluidic channel, such that the deformable substance of the microfluidic actuator enters the microfluidic channel to form a seal around the needle; and
injecting or extracting a fluid through the needle.
